(19) United States
(12) Patent Application Publication
(10) Pub. No.: US 2025/0126165 A1
(43) Pub. Date: Apr. 17, 2025

(54) VOICE QUALITY INFORMATION COLLECTING DEVICE, VOICE QUALITY INFORMATION COLLECTING METHOD, VOICE QUALITY INFORMATION COLLECTING SYSTEM, AND PROGRAM

(71) Applicant: Nippon Telegraph and Telephone Corporation, Tokyo (JP)

(72) Inventors: Kosuke WATANABE, Musashino-shi, Tokyo (JP); Takashi NAMBU, Musashino-shi, Tokyo (JP)

(21) Appl. No.: 18/834,062

(22) PCT Filed: Feb. 10, 2022
(86) PCT No.: PCT/JP2022/005258

§ 371 Date: Jul. 29, 2024

(51) Int. Cl. H04L 65/80; H04L 65/1023; H04L 65/1104; H04M 3/22

(52) U.S. Cl. CPC H04L 65/80; H04L 65/1023; H04L 65/1104; H04M 3/2236

(57) ABSTRACT

A voice quality information collection device includes a SIP server log collection unit for collecting a SIP server log including an incoming call number, identification information of a destination carrier, and a line number, from a SIP server, an MG log collection unit for collecting an MG log including a TerminationID allocated by a predetermined logic and a delay time calculated by an RTCP report, from an MG, and a data generation unit for converting a line number included in the SIP server log into a TerminationID and integrating the post-conversion SIP server log and the MG log by using a TerminationID, to generate log integration information.

### TECHNICAL FIELD

The present invention relates to a voice quality information collection device, a voice quality information collection method, a voice quality information collection system, and a program for collecting voice quality information in an IP telephone network.

### BACKGROUND ART

When a so-called PSTN migration (IP conversion of a fixed phone), which is a migration to an IP network of a PSTN (Public Switched Telephone Network), is completed, a metal IP telephone is started, and the IP connection is directly started with the other company's network without going through the PSTN.

In the conventional public IP telephone network, test calls are continuously made to each area using a test terminal to measure the voice quality in order to ensure a prescribed voice quality (see PTL 1). The quality measurement method at this time is performed in accordance with the guideline of the TTC (information communication technology committee) (see NPL 2).

### CITATION LIST

### Non Patent Literature

[NPL 1] “Additional Explanation Based on the First Meeting of the Communications Quality Study Ad Hoc Group,” NTT East, NTT West, May 15, 2012, [online], [retrieved on Feb. 1, 2022], Internet <URL: https://www.soumu.go.jp/main content/000160197.pdf>

[NPL 2] “TR-1054 Guidelines for Measuring IP Telephony Call Quality,” Information and Communication Technology Committee, Jun. 1, 2018, [online], [retrieved on Feb. 1, 2022], Internet <URL: https://www.ttc.or.jp/application/files/4515/5436/0209/TR-1054v3.pdf>

### SUMMARY OF INVENTION

### Technical Problem

However, in the case of measuring the quality of the IP telephone network according to the prior art described in NPL 1, it is necessary to provide a test terminal 8 and a measuring instrument 9 for measurement on the originating side and the destination side, as shown in FIG. 6. Therefore, equipment cost and operation cost are generated in quality measurement. Further, since measurement is performed after the test terminal 8 and the measuring instrument 9 for measurement are provided, when a report of voice quality deterioration or the like is provided by a user, voice quality information of a call actually used by the user cannot be acquired.

Further, in this quality measurement method, since test terminals are prepared on the originating side and the destination side, respectively, as shown in FIG. 7, when telephone service is provided by connecting IP networks through IP interconnection without the PSTN, it is not possible to measure the quality of the telephone service connecting to another company's network because the test terminals cannot be installed at the other company's network side. As a result, when a voice quality problem occurred in a telephone call to/from another company's network, it was difficult to isolate whether the failure is caused by the company's network or the other company's network.

In view of these points, the present invention was designed to reduce equipment and operation costs for voice quality measurement of an IP telephone network, and to acquire voice quality information in units of calls being used by the user.

### Solution to Problem

In order to solve the above problem, a voice quality information collection device according to the present invention is a voice quality information collection device for collecting voice quality information of a telephone service in which an IP telephone network of an originating carrier and an IP telephone network of a destination carrier are IP-interconnected, wherein an originating terminal of a telephone call is connected to an MG (Media Gateway), which converts between a metal line and an IP line, via a metal housing device, the voice quality information collection device comprising: a SIP server log collection unit that collects a SIP server log, which is a log that includes at least an incoming call number of a telephone call, identification information of the destination carrier, and a line number for uniquely identifying the telephone call, from a SIP (Session Initiation Protocol) server belonging to an area where the originating terminal is housed; an MG log collection unit that collects an MG log, which is a log that includes at least a start time and an end time of the telephone call, a TerminationID assigned to each line using a predetermined logic set in the MG, and a delay time of the telephone call calculated by the MG using a RTCP (Real Time Control Protocol) report, from the MG belonging to the area; and a data generation unit that generates a post-conversion SIP server log that indicates the SIP server log in which a line number included in the SIP server log is converted to the TerminationID by using the predetermined logic, and links a TerminationID included in the generated post-conversion SIP server log with a TerminationID included in the MG log, thereby generating log integration information for the telephone call that includes the start time and the end time, the incoming call number, the identification information of the destination carrier, and the delay time.

### Advantageous Effects of Invention

According to the present invention, not only is it possible to reduce equipment and operation costs for voice quality measurement of an IP telephone network, but also it is possible to voice quality information in units of calls being used by the user.

### BRIEF DESCRIPTION OF DRAWINGS

FIG. 1 is a diagram showing the entire configuration of a voice quality information collection system including a voice quality information collection device according to a present embodiment.

FIG. 2 is a diagram for explaining log integration information generation processing in which a SIP server clog and an MG log are used.

FIG. 3 is a diagram for explaining quality information generation processing executed by a quality information generation unit of the voice quality information collection device according to the present embodiment.

FIG. 4 is a sequence diagram showing a flow of processing executed by the voice quality information collection system including the voice quality information collection device according to the present embodiment.

FIG. 5 is a hardware configuration diagram showing an example of a computer that realizes functions of the voice quality information collection device according to the present embodiment.

FIG. 6 is a diagram for explaining a method of quality measurement of an IP telephone network prior to PSTN migration.

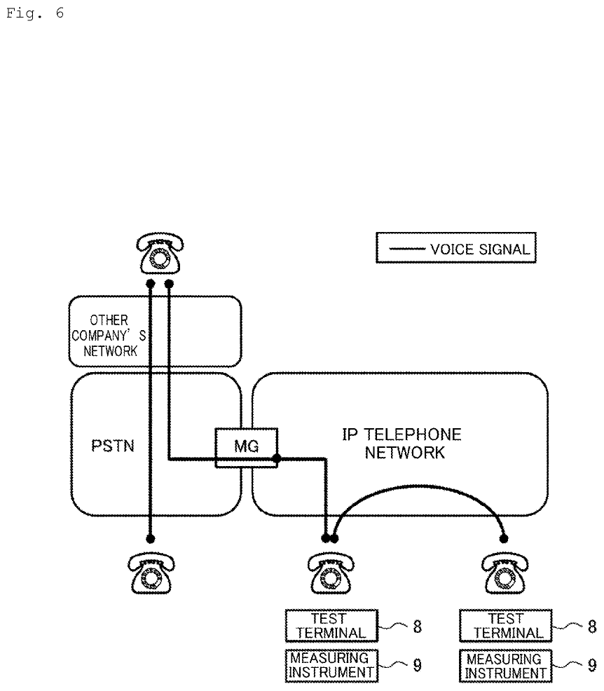

FIG. 7 is a diagram for explaining a problem of quality measurement with another company's network after an IP network migration.

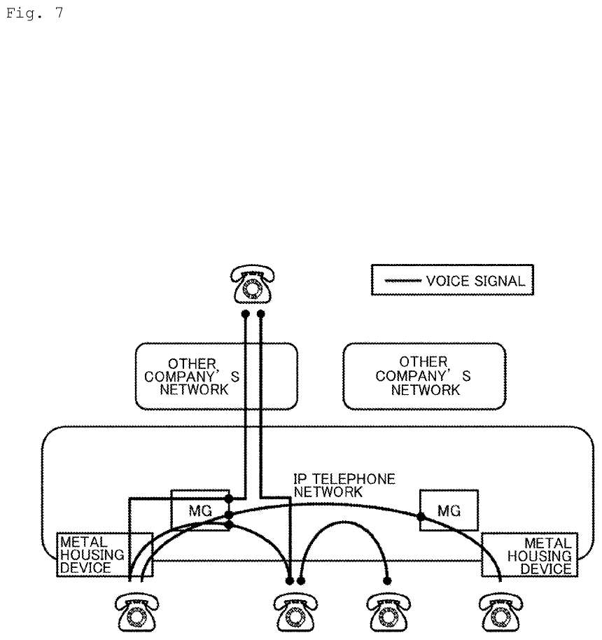

### DESCRIPTION OF EMBODIMENTS

Next, an embodiment for carrying out the present invention (hereinafter referred to as “the present embodiment”) will be described.

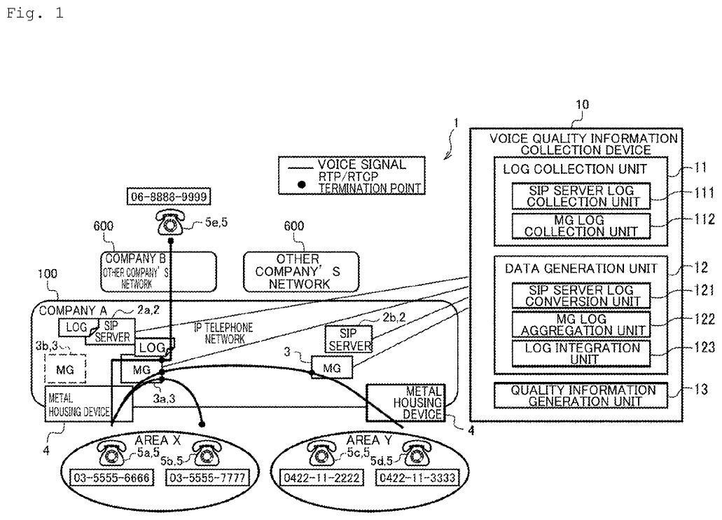

FIG. 1 is a diagram showing the entire configuration of a voice quality information collection system 1 including a voice quality information collection device 10 according to the present embodiment.

As shown in FIG. 1, in the present embodiment, it is assumed that PSTN migration (IP conversion of a fixed phone) has been completed, that a metal IP telephone has been started, and that IP connection has been initiated directly with an IP telephone network of another company (hereinafter referred to as “another company's network 600”) without going through the PSTN.

When the PSTN is migrated to the IP network, in the conventional fixed phone with a PSTN line, as shown by a terminal 5a, the conventional subscriber switching system is utilized as a metal housing device 4, and the metal line is used as it is. The fixed phone (terminal 5a) is connected to an IP telephone network 100 of a base company (company A) via an MG (Media Gateway) 3 for converting the metal line and the IP line. In the IP telephone network 100, a SIP (Session Initiation Protocol) server 2 performs call control such as call origination/termination and communication control, provides a communication service to IP telephones (terminals 5b, 5c) and a metal IP telephone (terminal 5d) of the base company's IP telephone network 100, and provides a communication service to an IP telephone (terminal 5e) and a metal IP telephone (not shown) of the other company's network 600.

A plurality of areas (area X and area Y in FIG. 1) are set as areas where fixed phones (terminals 5) such as metal IP telephones and IP telephones are installed. In these areas, one or more SIP servers 2 and one or more MGs 3 are arranged. The MGs 3 are communicatively connected to one or more metal housing devices 4, and the metal housing devices 4 are connected to a plurality of metal IP telephones by metal lines.

The voice quality information collection device 10 according to the present embodiment is communicatively connected to the SIP servers 2 and the MGs 3 in the IP telephone network 100 of the base company.

The voice quality information collection device 10 collects information on delay measurement where an RTCP (Real Time Control Protocol) handled by the MGs 3 is used in the IP telephone network 100, thereby collecting voice quality information in the IP telephone network including the other company's network 600.

The RTCP is a protocol for performing transmission/reception control when transmitting voice data or the like in real time by using an RTP (Real-time Transport Protocol) or the like, and sends a report of quality of data.

The voice quality information collection device 10 according to the present embodiment collects voice quality information in the IP telephone network, including the other companies' network 600, by using information on RTT (Round Trip Time) delay time (often referred to as “RTT delay information,” “delay time,” hereinafter) that can be created using the RTCP report received by the MG 3, which is an RTCP termination point.

### <Voice Quality Information Collection Device>

The voice quality information collection device 10 according to the present embodiment combines the RTT delay information per call unit contained in logs collected from the MGs 3, the incoming call number contained in logs collected from the SIP servers, and the destination carrier information, to collect voice data delay information per area in the base network and per other company.

The voice quality information collection device 10 is configured by a computer that includes a control unit, an input/output unit, and a storage unit (none of which is shown).

The input/output unit performs input and output of information to and from each SIP server 2, each MG 3, and the like of the base network. This input/output unit is configured by a communication interface for transmitting and receiving information through a communication line and an input/output interface for inputting and outputting information to and from an input device such as a keyboard, not shown, and an output device such as a monitor.

The storage unit is configured by a hard disk, a flash memory, a RAM (Random Access Memory), or the like.

This storage unit temporarily stores a program for executing each function of the control unit and information necessary for the processing of the control unit.

The control unit controls overall processing executed by the voice quality information collection device 10 and includes a log collection unit 11, a data generation unit 12, and a quality information generation unit 13, as shown in FIG. 1.

The log collection unit 11 collects logs related to telephone calls from the SIP servers 2 and the MGs 3 in the base network.

The log collection unit 11 includes a SIP server log collection unit 111 and an MG log collection unit 112.

The SIP server log collection unit 111 collects logs related to telephone calls from the SIP servers 2 (for example, a SIP server 2a in the area X in FIG. 1) belonging to an area to be subjected to voice quality measurement. Hereinafter, a log collected from a SIP server 2 is referred to as “SIP server log 20.”

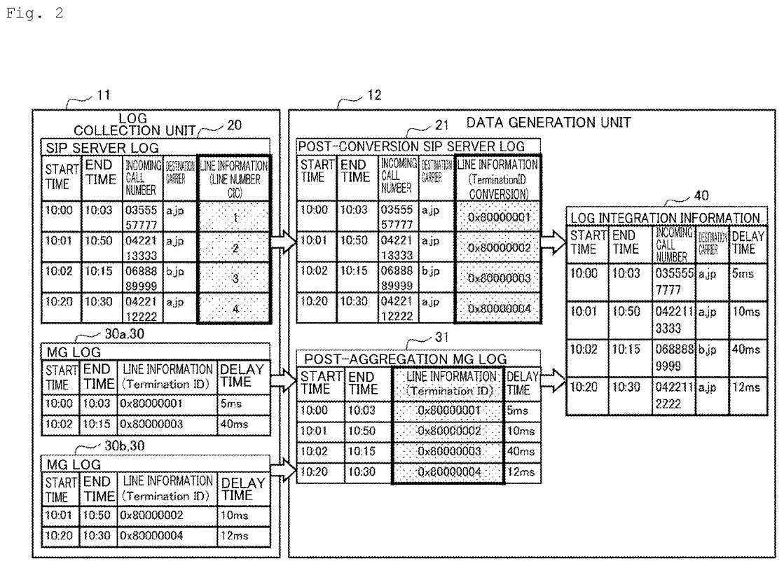

As shown in FIG. 2, this SIP server log 20 contains the following as information on each telephone call: a start time, an end time, an incoming call number (described as “incoming call number” in FIG. 2. The same applies hereafter), the identification information of the destination carrier (described as “destination carrier” in FIG. 2. The same applies hereinafter), and the line information (line number: CIC).

The start time and the end time are the time when the communication connection of a telephone call is started and the time when the communication connection is ended. The incoming call number is the phone number of a receiving terminal 5.

The identification information of the destination carrier (destination carrier) is information obtained from an IP address for identifying the carrier of the IP telephone network housing the receiving terminal 5.

The line information (line number: CIC) is a line number (CIC: Circuit Identification Code) and is information for uniquely identifying a telephone call.

The voice quality information collection device 10 may transmit an acquisition request for acquiring the SIP server log 20, to the SIP server 2 belonging to the area to be subjected to voice quality measurement, and collect it from the SIP server 2. Alternatively, the SIP server log 20 may be set to be transmitted from the SIP server 2 for each predetermined period of time set in advance, and the voice quality information collection device 10 may receive the SIP server logs 20.

Returning to FIG. 1, the MG log collection unit 112 collects logs related to telephone calls from the MGs 3 (e.g., MG 3a and MG 3b in FIG. 1) belonging to the same area as the SIP server 2 belonging to the area to be subjected to voice quality measurement. Hereinafter, the logs collected from the MGs 3 are referred to as “MG logs 30.”

In FIG. 2, an MG log 30a collected from the MG 3a of the area X and an MG log 30b collected from the MG 3b of the area X are shown.

As shown in FIG. 2, the start time, the end time, the line information (TerminationID), and the delay time are included in the MG logs 30 (30a, 30b) as the information on each telephone call.

The start time and the end time are the time when the communication connection of a telephone call is started and the time when each communication connection is ended.

The line information (TerminationID) is an identification number assigned to each line by the MG 3.

The delay time is the RTT delay time information (RTT delay information) calculated by each MG3 on a call-by-call basis from RTCP report.

The calculation of the RTT delay time by the MG 3 will be described.

The MG 3 calculates the RTT delay time by a report obtained by the RTCP which is a control protocol for RTP.

Specifically, the MG 3 transmits a RTCP SR (Sender Report) to the MG 3 or IP telephone (terminal 5) which is the receiving side, and stores the time of the transmission. The receiver side measures a time (T) from the reception of the RTCP SR to the transmission of a RTCT RR (Receiver Report), describes the measured time (T) in the RTCT RR, and responds to the MG3 on the transmission side. The MG3 on the transmission side calculates the difference between the time when the RTCP SR is transmitted and the time when the RTCT RR is received, and then calculates the RTT delay time by subtracting the time (T) described in the RTCT RR.

The voice quality information collection device 10 may transmit an acquisition request for acquiring the MG log 30, to the MG 3 belonging to the same area as the SIP server 2 belonging to the area to be subjected to voice quality measurement, and collect the MG log 30 from each MG 3. Alternatively, the MG log 30 may be set to be transmitted from each MG 3 for each predetermined period of time set in advance, and the voice quality information collection device 10 may receive the MG logs 30.

Returning to FIG. 1, the data generation unit 12 links the SIP server log 20 with the MG log 30 with line information, to generate log integration information 40 (see FIG. 2) on a call-by-call basis.

The data generation unit 12 includes a SIP server log conversion unit 121, an mg log aggregation unit 122, and a log integration unit 123.

The SIP server log conversion unit 121 converts the line information (line number: CIC) included in the SIP server log 20 into a TerminationID which is a format of the line information described in the MG log 30. The SIP server log obtained after converting the line information into the TerminationID is called “post-conversion SIP server log 21.”

The SIP server log conversion unit 121 converts the line number (CIC) into a TerminationID by using the same logic as a predetermined logic (TerminationID generation logic) used for the generation of the TerminationID in the MG 3, and generates the post-conversion SIP server log 21 (see FIG. 2).

The TerminationID generation logic can be arbitrarily set by the carrier of each IP telephone network. The SIP server log conversion unit 121 generates a TerminationID as information capable of uniquely specifying a line, by using the same prescribed logic as the MG 3 by using voice channel information of a communication channel used by the line number (CIC), for example.

Returning to FIG. 1, the MG log aggregation unit 122 aggregates a plurality of MG logs 30 (MG logs 30a, 30b in FIG. 2) collected from each MG 3, when a plurality of MGs 3 exist in the area to be subjected to voice quality measurement. The MG log obtained after aggregating the plurality of MG logs 30 is referred to as “post-aggregation MG log 31.” If there is one MG 3, the MG logs 30 become the post-aggregation MG log 31″ as is.

Specifically, the MG log aggregation unit 122 integrates and time-sequentially sorts the plurality of MG logs 30 on the basis of the start time of the call, and generates a post-aggregation MG log 31 (see FIG. 2).

The reason why the MG log aggregation unit 122 performs time-series sorting for the MG logs 30 is that when voice channel information is used to generate the TerminationID, there is a possibility that the same TerminationID is generated after a predetermined time has elapsed, due to the limitation of the number of audio channels. By using the time information, even when there is a telephone call with the same TerminationID, the telephone call can be uniquely specified because of a different call start time.

Returning to FIG. 1, the log integration unit 123 integrates the post-conversion SIP server log 21 obtained by converting line information into a TerminationID by the SIP server log conversion unit 121 and the post-aggregation MG log 31 obtained by aggregating the plurality of MG logs 30 by the MG log aggregation unit 122, to generate the log integration information 40 integrated by the TerminationID.

Specifically, the log integration unit 123 integrates the two logs by using a TerminationID which is information common to the post-conversion SIP server log 21 and the post-aggregation MG log 31, to generate the log integration information 40 (see FIG. 2).

As shown in FIG. 2, the log integration information 40 includes, as information on each telephone call, a start time, an end time, an incoming call number (incoming call number), a destination carrier, and a delay time.

Thus, the voice quality information collection device 10 can acquire the voice quality information on a per-call basis while the user actually uses the system.

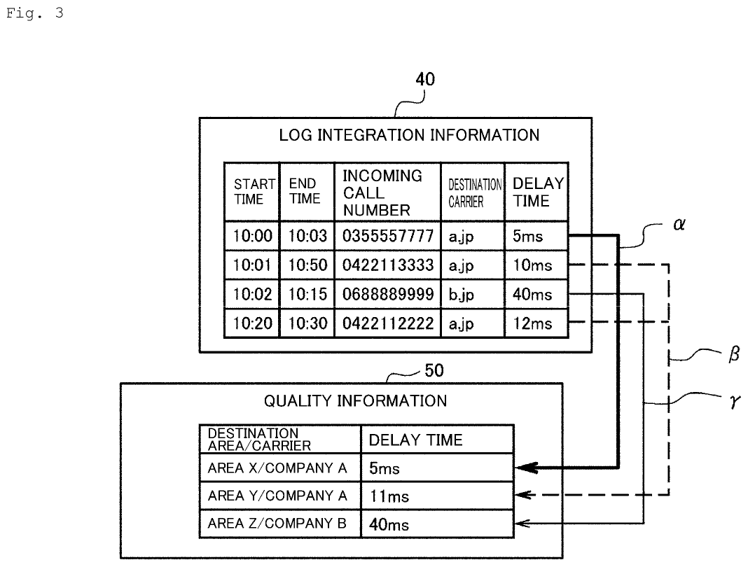

Returning to FIG. 1, the quality information generation unit 13 uses the log integration information 40 generated by the log integration unit 123, to group telephone calls in units of the destination area and the destination carrier, based on the information of the incoming call number and the incoming carrier shown in the log integration information 40, and aggregates the delay time information to generate quality information 50 (see FIG. 3).

Here, the quality information generation unit 13 acquires information of an area specified by a 0ABJ number starting from an area code, by searching for the incoming call number with any number of digits from one to all digits of the forward match.

The quality information generation unit 13 also specifies the destination carrier on the basis of the identification information of the destination carrier obtained from the IP address.

FIG. 3 is a diagram for explaining the generation processing of generating the quality information 50 executed by the quality information generation unit 13 of the voice quality information collection device 10 according to the present embodiment.

The quality information generation unit 13 specifies the “area X” which is an area such as the 23 wards of Tokyo, on the basis of the incoming call number “03,” as indicated by a symbol a in FIG. 3. Also, the base company “company A” is specified on the basis of a destination carrier “a. JP.” Then, the delay time of the destination carrier in this destination area is set to “5 ms.”

Further, as indicated by a symbol (in FIG. 3, the “area Y” which is an area such as Tokyo Musashino city is specified on the basis of an incoming call number “0422.” Also, the base company “company A” is specified on the basis of a destination carrier “a. JP.” Then, as the delay time of the destination carrier in the destination area, for example, two pieces of delay information “10 ms” and “12 ms” are averaged to “11 ms.” Further, as indicated by a symbol y in FIG. 3, the “area Z” which is an area in Osaka City is specified on the basis of an incoming call number “06.” Also, the other company “company B” is specified on the basis of a destination carrier “b.jp.” Then, the delay time of the destination carrier in this destination area is set to “40 ms.”

The quality information generation unit 13 groups telephone calls in units of destination areas and destination carriers in the log integration information 40, and totals delay times of telephone calls shared by the destination areas and the destination carriers on the basis of a predetermined totaling logic. For example, the quality information generation unit 13 can information such as the average value, maximum value, minimum value, and variance of the delay times on the basis of the delay time of the quality information 50, to generate the quality information 50 (see FIG. 3).

When unable to specify the area because the receiving terminal 5 is not a metal IP telephone (fixed phone) and the telephone number does not conform to the area defined by the 0ABJ number, the quality information generation unit 13 uses the information of the destination carrier that can be specified (e.g., “company B”), to generate the information on the delay time for the whole destination carrier without specifying the area.

In the quality information 50 shown in FIG. 3, the delay time of the company B is 40 ms as compared with the delay times of the company A being 5 ms and 11 ms. Therefore, it can be understood that the IP telephone network on the company A side has no problem in voice quality, and the IP telephone network on the company B side has a problem in voice quality (delay).

As described above, according to the voice quality information collection system 1 including the voice quality information collection device 10 according to the present embodiment, it is not necessary to provide a test terminal and a measuring instrument when acquiring the quality information of an IP telephone network. Therefore, equipment cost and operation cost incurred in voice quality measurement can be reduced. The voice quality information collection device 10 can also acquire voice quality information on a call-by-call basis while the user uses the system.

Furthermore, since the voice quality information collection device 10 can acquire information on voice quality in a telephone call with the other company's network, the voice quality information collection device 10 can compare voice quality information of a telephone call under IP connection with the other company's network with voice quality information of the telephone call in the base network. This will make it easier to isolate voice quality problems when said problems occur and reduce the time required to resolve said problems.

### <<Processing Flow>>

Next, a flow of processing executed by the voice quality information collection system 1 including the voice quality information collection device 10 according to the present embodiment will be described.

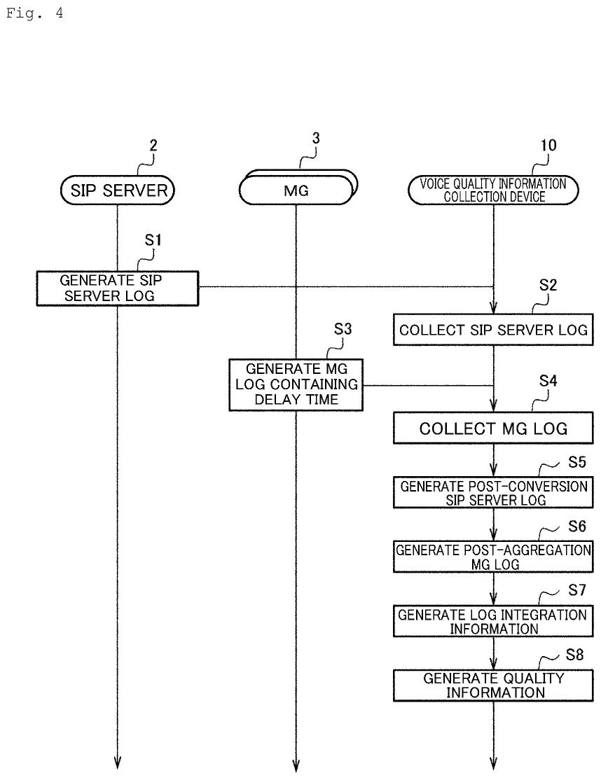

FIG. 4 is a sequence diagram showing a flow of processing executed by the voice quality information collection system 1 including the voice quality information collection device 10.

First, the SIP server 2 belonging to a certain area generates a SIP server log 20 (see FIG. 2) (step S1) and transmits it to the voice quality information collection device 10.

Then, the log collection unit 11 (SIP server log collection unit 111) of the voice quality information collection device 10 collects the SIP server log 20 (step S2).

This SIP server log 20 includes at least an incoming call number, identification information of a destination carrier, and information of a line number (CIC) as line information.

One or more MGs 3 belonging to the same area as the area to which the SIP server 2 belongs generate MG logs 30 (see FIG. 2) (step S3). In this case, the MGs 3 calculate the RTT delay time (delay time) by using the RTCP report. The MG logs 30 include at least a start time, end time, delay time, and the TerminationID assigned by the MGs 3 as line information. The MGs 3 transmit the generated MG logs 30 to the voice quality information collection device 10.

Then, the log collection unit 11 (MG log collection unit 112) of the voice quality information collection device 10 collects the MG logs 30 (step S4).

The processing of collecting the SIP server log 20 in steps S1 and S2 and the processing of collecting the MG logs 30 in steps S3 and S4 can be performed in any order.

The data generation unit 12 (SIP server log conversion unit 121) of the voice quality information collection device 10 converts the line information (line number: CIC) included in the SIP server log 20 into a TerminationID which is a format of line information described in the MG logs 30 on the basis of a predetermined logic, and generates the post-conversion SIP server log 21 (see FIG. 2) (step S5).

The MG log aggregation unit 122 of the voice quality information collection device 10 aggregates the plurality of MG logs 30 collected from the respective MGs 3, to generate the post-aggregation MG log 31 (see FIG. 2) (step S6). The processing of steps S5 and S6 can be performed in any order.

Next, the data generation unit 12 (log integration unit 123) of the voice quality information collection device 10 integrates the post-conversion SIP server log 21 and the post-aggregation MG log 31 by the TerminationID, to generate the log integration information 40 (see FIG. 2) (step S7).

Subsequently, the quality information generation unit 13 of the voice quality information collection device 10 groups telephone calls in units of destination areas and destination carriers on the basis of the incoming call number and the information on the destination carrier indicated by the log integration information 40, totals the information on the delay times on the basis of a prescribed totaling logic, to generate the quality information 50 (see FIG. 3) (step S8). Here, the predetermined totaling logic is set in advance as, for example, the average value, maximum value, minimum value, and variance of the delay times.

Thus, since the voice quality information collection system 1 can collect the voice quality information of an IP telephone network without providing a test terminal or a measuring instrument, equipment cost and operation cost incurred in voice quality measurement can be reduced. The voice quality information collection device 10 can also acquire voice quality information on a call-by-call basis while the user uses the system. In addition, since the voice quality information collection device 10 can acquire the quality information with the terminal 5 belonging to the other company's network, it is possible to easily isolate voice quality problems when said problems occur.

### <Hardware Configuration>

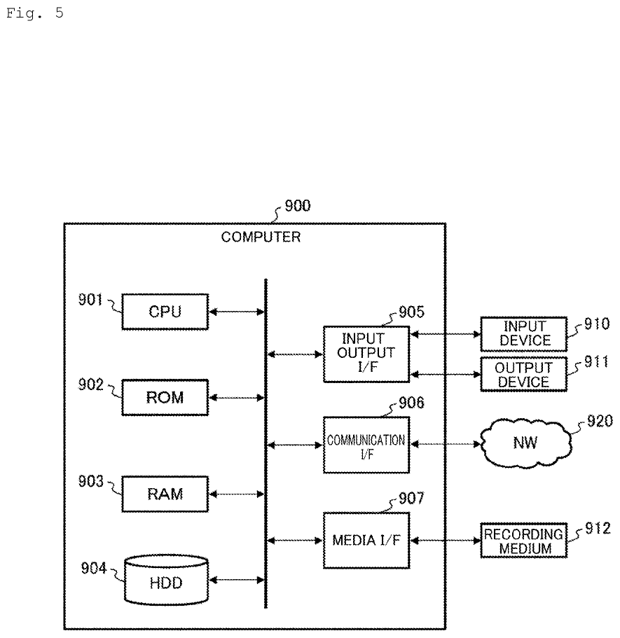

The voice quality information collection device 10 according to the present embodiment is realized by, for example, a computer 900 having a configuration as shown in FIG. 5. FIG. 5 is a hardware configuration diagram showing an example of the computer 900 that realizes functions of the voice quality information collection device 10 according to the present embodiment. The computer 900 has a CPU (Central Processing Unit) 901, a ROM (Read Only Memory) 902, a RAM 903, an HDD (Hard Disk Drive) 904, an input/output I/F (Interface) 905, a communication I/F 906, and a media I/F 907.

The CPU 901 operates on the basis of a program stored in the ROM 902 or the HDD 904 and causes the control unit to perform control. The ROM 902 stores a boot program executed by the CPU 901 when the computer 900 is activated, a program related to the hardware of the computer 900, and the like.

The CPU 901 controls an input device 910 such as a mouse and a keyboard, and an output device 911 such as a display and a printer through the input and output I/F 905. The CPU 901 acquires data from the input device 910 through the input and output I/F 905 and outputs the generated data to the output device 911. Note that a GPU (Graphics Processing Unit) or the like may be used as a processor together with the CPU 901.

The HDD 904 stores a program executed by the CPU 901, data used by the program, and the like. The communication I/F 906 receives data from other devices through a communication network (e.g., a NW (Network) 920), outputs said data to the CPU 901, and transmits data generated by the CPU 901 to other devices through the communication network.

The media I/F 907 reads a program or data stored in a recording medium 912 and outputs said program or data to the CPU 901 through the RAM 903. The CPU 901 loads a program related to desired processing from the recording medium 912 onto the RAM 903 through the media I/F 907, and executes the loaded program. The recording medium 912 is an optical recording medium such as a DVD (Digital Versatile Disc) or a PD (Phase change rewritable Disk), a magneto optical recording medium such as a MO (Magneto Optical disk), a magnetic recording medium, and a semiconductor memory.

For example, when the computer 900 serves as the voice quality information collection device 10 of the present invention, the CPU 901 of the computer 900 realizes the functions of the voice quality information collection device 10 by executing a program loaded on the RAM 903. Further, data in the RAM 903 is stored in the HDD 904. The CPU 901 reads a program related to target processing from the recording medium 912 and executes the program. In addition, the CPU 901 may read a program related to desired processing from other devices through the communication network (NW 920).

### <Effect>

The effects of the voice quality information collection device 10 and the like according to the present invention will be described below.

A voice quality information collection device according to the present invention is the voice quality information collection device 10 for collecting voice quality information of a telephone service in which an IP telephone network 100 of an originating carrier and an IP telephone network 600 of a destination carrier are IP-interconnected, wherein an originating terminal of a telephone call is connected to the MG 3, which converts between a metal line and an IP line, via the metal housing device 4, the voice quality information collection device 10 comprising: the SIP server log collection unit 111 that collects the SIP server log 20, which is a log that includes at least an incoming call number of a telephone call, identification information of the destination carrier, and a line number for uniquely identifying the telephone call, from the SIP server 2 belonging to an area where an originating terminal 5 is located; the MG log collection unit 112 that collects the MG log 30, which is a log that includes at least a start time and an end time of the telephone call, a TerminationID assigned to each line using a predetermined logic set in the MG 3, and a delay time of the telephone call calculated by the MG 3 using a RTCP report, from the MG 3 belonging to the area; and the data generation unit 12 that generates the post-conversion SIP server log 21 that indicates the SIP server log in which a line number included in the SIP server log 20 is converted to the TerminationID by using the predetermined logic, and links a TerminationID included in the generated post-conversion SIP server log 21 with a TerminationID included in the MG log 30, thereby generating the log integration information 40 for the telephone call that includes the start time and the end time, the incoming call number, the identification information of the destination carrier, and the delay time.

Thus, according to the voice quality information collection device 10, it is not necessary to provide a test terminal and a measuring instrument as in the prior art when acquiring the quality information of an IP telephone network. Therefore, equipment cost and operation cost incurred in voice quality measurement can be reduced.

In addition, in the prior art, since line information is calculated by different logic in the log of the SIP server 2 and the log of the MG 3, the logs cannot be integrated. On the other hand, the voice quality information collection device 10 can generate the log integration information 40 obtained by integrating the SIP server log 20 and the MG log 30 for each telephone call. Thus, the voice quality information collection device 10 can acquire the voice quality information in units of calls being used by the user. Thus, when a report of voice quality deterioration or the like is provided by the user, voice quality information of a call actually used by the user cannot be acquired.

The voice quality information collection device according to the present invention further comprises the quality information generation unit 13 that specifying a destination area indicating an area to which a destination terminal belongs, from the incoming call number, specifies a destination carrier from the identification information of the destination carrier, groups the log integration information 40 in units of destination areas and destination carriers, and totals delay information of telephone calls to generate quality information.

Thus, since the voice quality information collection device 10 can acquire information on voice quality in a telephone call with another company's network, the voice quality information collection device 10 can compare voice quality information of a telephone call under IP connection with the other company's network with voice quality information of the telephone call in the base network. This will make it easier to isolate voice quality problems when said problems occur and reduce the time required to resolve said problems.

Note that the present invention is not limited to the embodiment described above, and many variations are possible by those having ordinary knowledge in the art within the technical concept of the present invention.

### REFERENCE SIGNS LIST

1 Voice quality information collection system
2 SIP server
3 MG (media gateway)
4 Metal housing device
5 Terminal (metal IP telephone, IP telephone)
10 Voice quality information collection device
11 Log collection unit
12 Data generation unit
13 Quality information generation unit
20 SIP server log
21 Post-conversion SIP server log
30 MG log
31 Post-aggregation MG log
40 Log integration information
50 Quality information
111 SIP server log collection unit
112 MG log collection unit
121 SIP server log conversion unit
122 MG log aggregation unit
123 Log integration unit

1. A voice quality information collection device for collecting voice quality information of a telephone service in which an IP telephone network of an originating carrier and an IP telephone network of a destination carrier are IP-interconnected, wherein an originating terminal of a telephone call is connected to an MG (Media Gateway), which converts between a metal line and an IP line, via a metal housing device, the voice quality information collection device comprising one or more processors configured to execute instructions that cause the voice quality information collection device to perform operations comprising:
collecting a SIP server log, which is a log that includes at least an incoming call number of a telephone call, identification information of the destination carrier, and a line number for uniquely identifying the telephone call, from a SIP (Session Initiation Protocol) server belonging to an area where the originating terminal is housed;
collecting an MG log, which is a log that includes at least a start time and an end time of the telephone call, a TerminationID assigned to each line using a predetermined logic set in the MG, and a delay time of the telephone call calculated by the MG using a RTCP (Real Time Control Protocol) report, from the MG belonging to the area; and
generating a post-conversion SIP server log that indicates the SIP server log in which a line number included in the SIP server log is converted to the TerminationID by using the predetermined logic, and links a TerminationID included in the generated post-conversion SIP server log with a TerminationID included in the MG log, thereby generating log integration information for the telephone call that includes the start time and the end time, the incoming call number, the identification information of the destination carrier, and the delay time.

2. The voice quality information collection device according to claim 1, the operations further comprising: specifying a destination area indicating an area to which a destination terminal belongs, from the incoming call number, specifying the destination carrier from the identification information of the destination carrier, grouping the log integration information in units of the destination area and in units of the destination carrier, and aggregating delay information of the telephone call, to generate quality information.

3. A voice quality information collection method of a voice quality information collection device for collecting voice quality information of a telephone service in which an IP telephone network of an originating carrier and an IP telephone network of a destination carrier are IP-interconnected, wherein an originating terminal of a telephone call is connected to an MG (Media Gateway) that converts between a metal line and an IP line, via a metal housing device, the method comprising:
collecting a SIP (Session Initiation Protocol) server log, which is a log that includes at least an incoming call number of a telephone call, identification information of the destination carrier, and a line number for uniquely identifying the telephone call, from a SIP (Session Initiation Protocol) server belonging to an area where the originating terminal is housed;
collecting an MG log, which is a log that includes at least a start time and an end time of the telephone call, a TerminationID assigned to each line using a predetermined logic set in the MG, and a delay time of the telephone call calculated by the MG using a RTCP (Real Time Control Protocol) report, from the MG belonging to the area; and
generating a post-conversion SIP server log that indicates the SIP server log in which a line number included in the SIP server log is converted to the TerminationID by using the predetermined logic, and linking a TerminationID included in the generated post-conversion SIP server log with a TerminationID included in the MG log, thereby generating log integration information for the telephone call that includes the start time and the end time, the incoming call number, the identification information of the destination carrier, and the delay time.

4. The voice quality information collection method according to claim 3, further comprising:
specifying a destination area indicating an area to which a destination terminal belongs, from the incoming call number, specifying the destination carrier from the identification information of the destination carrier, grouping the log integration information in units of the destination area and in units of the destination carrier, and aggregating delay information of the telephone call, to generate quality information.

5. A voice quality information collection system comprising:
a voice quality information collection device comprising one or more processors configured to perform operations comprising collecting voice quality information of a telephone service in which an IP telephone network of an originating carrier and an IP telephone network of a destination carrier are IP-interconnected;
an MG (Media Gateway) that is connected to a metal housing device configured to house an originating terminal and converts between a metal line and an IP line; and
a SIP (Session Initiation Protocol) server that performs connection control of a telephone call within an IP telephone network,
wherein
the SIP server belonging to an area in which the originating terminal is housed generates a SIP server log that is a log including at least an incoming call number of a telephone call, identification information of the destination carrier, and a line number for uniquely identifying the telephone call, and transmits the SIP server log to the voice quality information collection device,
the MG belonging to the area generates an MG log, which is a log that includes at least a start time and an end time of the telephone call, a TerminationID assigned to each line using a predetermined logic set in the MG, and a delay time of the telephone call calculated by the MG using a RTCP (Real Time Control Protocol) report, and transmits the MG log to the voice quality information collection device,
the operations further comprise:
collecting the SIP server log and the MG log, and
generating a post-conversion SIP server log that indicates the SIP server log in which a line number included in the SIP server log is converted to the TerminationID by using the predetermined logic, and links a TerminationID included in the generated post-conversion SIP server log with a TerminationID included in the MG log, thereby generating log integration information for the telephone call that includes the start time and the end time, the incoming call number, the identification information of the destination carrier, and the delay time.

6. The voice quality information collection system according to claim 5, wherein the operations further comprise:
specifying a destination area indicating an area to which a destination terminal belongs, from the incoming call number,
specifying the destination carrier from the identification information of the destination carrier,
grouping the log integration information in units of the destination area and in units of the destination carrier, and
aggregating delay information of the telephone call, to generate quality information.

7. (canceled)
